(19) United States
(12) Patent Application Publication
(10) Pub. No.: US 2008/0137743 A1
(43) Pub. Date: Jun. 12, 2008

(54) INTRA-MODE PREDICATION SEARCH METHOD AND APPARATUS FOR COMPRESSION OF REAL-TIME VIDEO SIGNAL

(75) Inventors: Byung Gyu Kim, Busan (KR); Jong Ho Kim, Busan (KR); Chang Sik Cho, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 11/950,718

(22) Filed: Dec. 5, 2007

(30) Foreign Application Priority Data
Dec. 6, 2006 (KR) 10-2006-0122870
Jun. 29, 2007 (KR) 10-2007-0064972

(51) Int. Cl. H04N 7/48

(52) U.S. Cl. 375/240.13; 375/E07.21

(57) ABSTRACT

Provided is an intra-mode prediction search method for compression of a real-time video signal, the method including the steps of: measuring a Rate-Distortion (R-D) cost of a video-signal macro block received from outside; determining a search threshold value by comparing the R-D cost of the received macro block with R-D costs of neighboring macro blocks; determining an inter mode having the minimum sum of absolute error (SAE) by measuring the SAE of the received macro block for each inter mode; and determining an intra-mode prediction search in response to the minimum SAE of the determined inter mode and the search threshold value.

### CROSS-REFERENCE TO RELATED APPLICATION

This application claims priority to and the benefit of Korean Patent Application No. 2006-122870, filed Dec. 6, 2006, and No. 2007-64972, filed Jun. 29, 2007, the disclosure of which is incorporated herein by reference in its entirety.

### BACKGROUND

1. Field of the Invention

The present invention relates to an intra-mode prediction search method and apparatus for compression of a real-time video signal.

The present invention has been produced from the work supported by the IT R&D program of MIC (Ministry of Information and Communication)/IITA (Institute for Information Technology Advancement) [2005-S-022-02, Embedded Software-based SmarTown Solution] in Korea.

2. Discussion of Related Art

The H.264 scheme is the latest international video encoding standard that is provided as a currently used real-time video signal compression method. Although the H.264 scheme exhibits a higher performance than previous video encoding schemes in terms of Rate-Distortion (R-D), the complexity of a encoder is considerably increased.

In the H.264 scheme, a screen is divided into macro blocks for compression of a video signal, and an inter-mode prediction search and an intra-mode prediction search are all performed on the respective macro blocks. Then, the respective blocks are compressed so as to compress the entire video screen in real time.

FIGS. 8 and 9 are diagrams showing the kinds of variable blocks for determining an inter mode and modes defined for an intra-mode search in the H.264 scheme.

7 kinds of inter modes are provided as the inter mode, as shown in FIG. 8. To determine a final inter mode, 7 kinds of R-D costs are measured for the respective macro blocks, thereby determining a mode having the minimum value.

As shown in FIG. 9, the intra-mode has three kinds of block sizes, that is, 4×4, 8×8, and 16×16. For an Intra 16×16 Luminance Macro Block (I16×16 MB), i.e., a black and white 16×16 macro block, four modes (prediction directions) exist. For an I4×4 MB, nines modes exist. Further, for a chrominance (Chroma) 8×8 block, four modes exist.

Even in the intra-mode search, a mode having the minimum residual data is selected as a final intra-mode.

As described above, the inter-mode prediction search and the intra-mode prediction search are all performed in the H.264 scheme. Therefore, the configuration of an encoder becomes complex. As a result, power consumption increases, and operating speed decreases.

Accordingly, research has been conducted into various methods for reducing the complexity of the encoder.

### SUMMARY OF THE INVENTION

The present invention is directed to an intra-mode prediction search method and apparatus for compression of a real-time video signal.

The present invention is also directed to accelerating an intra-mode prediction search of inter-mode prediction and intra-mode prediction schemes, thereby improving the performance of a H.264 video compression system in terms of bit rate and compression speed.

According to one aspect of the present invention, an intra-mode prediction search method for compression of a real-time video signal includes the steps of: measuring a Rate-Distortion (R-D) cost of a video-signal macro block received from outside; determining a search threshold value by comparing the R-D cost of the received macro block with R-D costs of neighboring macro blocks; determining an inter mode having the minimum sum of absolute error (SAE) by measuring the SAE of the received macro block for each inter mode; and determining an intra-mode prediction search in response to the minimum SAE of the determined inter mode and the search threshold value.

In the step of determining the intra-mode prediction search, when the minimum SAE of the determined inter mode exceeds the search threshold value, the intra-mode prediction search may be skipped. Further, when the minimum SAE of the determined inter mode is smaller than or equal to the search threshold value, the intra-mode prediction search may be performed in response to the inter mode having the minimum SAE.

The method may further include the step of, when the inter mode having the minimum SAE is a 16×16 mode, predicting and searching an optimal intra-mode by performing the intra-mode prediction search in an Intra 16×16 Macro Block Luminance (I16 MB):DC mode and an Intra 8×8 Chrominance (Chroma):DC mode and skipping the intra-mode prediction search in an I4 MB:DC mode. In addition, the method may further include the step of, when the inter mode having the minimum SAE is a 16×8 mode, predicting and searching an optimal intra-mode by performing the intra-mode prediction search in an I16 MB:DC and HOR mode and the Intra 8×8 Chroma:DC mode and skipping the intra-mode prediction search in the I4 MB:DC mode.

The method may further include the step of, when the inter mode having the minimum SAE is an 8×16 mode, predicting and searching an optimal intra-mode by performing the intra-mode prediction search in an I16 MB:DC and VER mode and the Intra 8×8 Chroma:DC mode and skipping the intra-mode prediction search in the I4 MB:DC mode.

The method may further include the step of: when the inter mode having the minimum SAE has an 8×8 sub-block, performing the intra-mode prediction search in the I16 MB:DC mode and the Intra 8×8 Chroma:DC mode; when the sub-block mode is an 8×4 mode, performing the intra-mode prediction search in the I4 MB:DC and HOR mode; when the sub-block mode is any one of an 8×8 mode and a 4×4 mode, performing the intra-mode prediction search in the I4 MB:DC mode; and when the sub-block mode is a 4×8 mode, performing the intra-mode prediction search in the I4 MB:DC and VER mode.

According to another aspect of the present invention, an apparatus for intra-mode prediction search for compression of a real-time video signal includes: a threshold value determining unit for measuring an R-D cost of a video-signal macro block received from outside and determining a search threshold value by comparing the R-D cost of the received macro block with R-D costs of neighboring macro blocks; an inter-mode calculating unit for measuring the sum of absolute error (SAE) of the received macro block for each inter mode; a final-inter-mode determining unit for determining a final inter mode having the minimum SAE for the respective inter modes by comparing the measured SAEs; and an intra-mode determining unit for determining an intra-mode prediction search in response to the minimum SAE of the determined final inter mode and the search threshold value.

The intra-mode determining unit may skip the intra-mode prediction search when the minimum SAE of the determined final inter mode exceeds the search threshold value. Further, the intra-mode determining unit may include an intra-mode calculating unit for predicting and searching an intra-mode in response to the final inter mode having the minimum SAE.

The intra-mode calculating unit may include a 16×16 intra-mode predicting and searching section for predicting and searching an optimal intra-mode by performing the intra-mode prediction search in the I16 MB:DC mode and the Intra 8×8 Chroma:DC mode and skipping the intra-mode prediction search in the I4 MB:DC mode. Further, the intra-mode calculating unit may include a 16×8 intra-mode predicting and searching section for predicting and searching an optimal intra-mode by performing the intra-mode prediction search in the I16 MB:DC and HOR mode and the Intra 8×8 Chroma:DC mode and skipping the intra-mode prediction search in the I4 MB:DC mode.

In addition, the intra-mode calculating unit may include an 8×16 intra-mode predicting and searching section for predicting and searching an optimal intra-mode by performing the intra-mode prediction search in the I16 MB:DC and VER mode and the Intra 8×8 Chroma:DC mode and skipping the intra-mode prediction search in the I4 MB:DC mode.

Further, the intra-mode calculating unit may include an 8×8 sub-block intra-mode predicting and searching section for performing the intra-mode prediction search in at least one of the I16 MB:DC mode, the Intra 8×8 Chroma:DC mode, an I4 MB:DC and HOR mode, the I4 MB:DC mode, and an I4 MB:DC and VER mode.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a video compressor to which the present invention is applied;

FIG. 2 is a flow chart simply showing the operation sequence of the video compressor to which the present invention is applied;

FIG. 3 is a diagram schematically showing the sequence for motion prediction according to the related art, which is compared with the present invention;

FIG. 4 is a diagram for explaining macro blocks applied in a H.264 scheme;

FIG. 5 is a schematic view of a motion predictor for screen motion prediction according to an exemplary embodiment of the present invention;

FIG. 6 is a diagram schematically showing the sequence for screen motion prediction according to an exemplary embodiment of the present invention;

FIG. 7 is a diagram showing an intra-mode search method based on an inter mode according to an exemplary embodiment of the present invention;

FIG. 8 is a diagram showing kinds of inter-mode variable blocks in the H.264 scheme;

FIG. 9 is a diagram showing intra-mode prediction search modes in the H.264 scheme; and

FIG. 10 is a diagram for explaining an actual exemplary embodiment when the present invention is applied.

### DETAILED DESCRIPTION OF EXEMPLARY EMBODIMENTS

Hereinafter, the present invention will be described in detail with reference to the accompanying drawings.

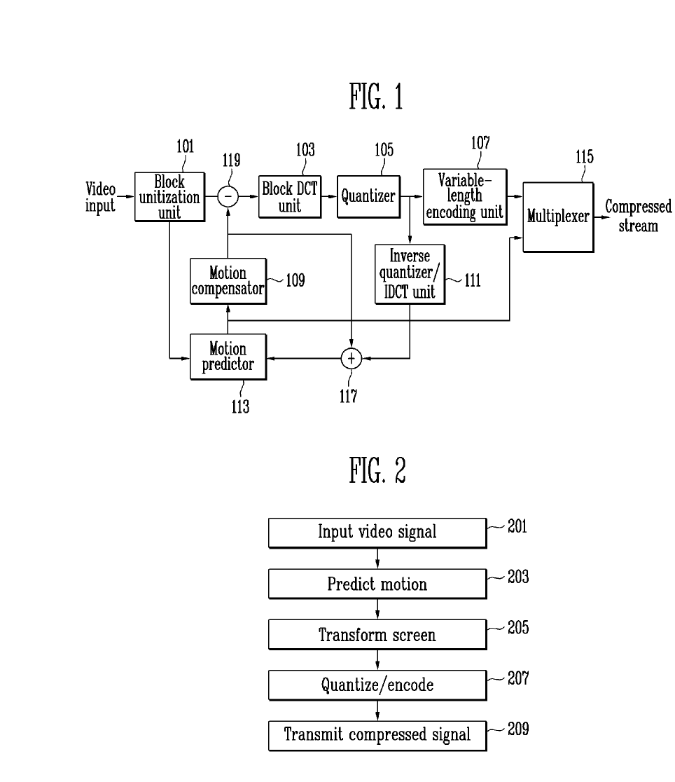

FIG. 1 is a schematic view of a video compressor to which the present invention is applied.

Referring to FIG. 1, the video compressor includes a block unitization unit 101, a block Discrete Cosine Transform (DCT) unit 103, a quantizer 105, a variable-length encoding unit 107, a motion compensator 109, an inverse quantizer and inverse-DCT (IDCT) unit 111, a motion predictor 113, a multiplexer 115, a subtractor 119 and an adder 117.

The block unitization unit 101 serves to divide a video signal input frame by frame from outside into blocks. This is performed for setting macro blocks which are used in the motion predictor 113 to predict the video signal.

The block DCT unit 103 serves to DCT a signal in which the subtraction operation of the block unitization unit 101 and the motion compensator 109 is performed by the subtractor 119. The block DCT unit 103 transforms a pixel into a frequency.

The quantizer 105 serves to quantize the signal transformed by the block DCT unit 103 to transform the signal into a digital signal. The variable-length encoding unit 107 variable-length encodes the signal quantized by the quantizer 105 so as to generate a compressed stream to transmit the signal to the outside.

The inverse quantizer and IDCT unit 111 serves to inversely quantize and inversely DCT the signal quantized by the quantizer 105 so as to reproduce the original frame.

The motion predictor 113 serves to predict motion using the video input signal received from the block unitization unit 101, and a signal into which the adder 117 has added the previous frame reproduced by the inverse quantizer and IDCT unit 111 and the signal received from the motion compensator 109. The motion predictor 113 performs an intra-mode prediction search and an inter-mode prediction search.

The motion compensator 109 serves to subtract the compensated motion from the original frame, in combination with the block unitization unit 101 and the subtractor 119.

The multiplexer 115 multiplexes the compressed video stream to transmit the compressed video stream.

FIG. 2 is a flow chart simply showing the operation sequence of the video compressor to which the present invention is applied.

Referring to FIG. 2, a video signal is input to the video compressor (step 201). Then, the input signal is blocked, and a motion in a frame is predicted based on the blocked signal (step 203). For the motion prediction, the inter-mode prediction and the intra-mode prediction of the H.264 scheme can be used.

When the motion prediction is completed, the block DCT unit transforms a screen (step 205), and the transformed screen is quantized and encoded so as to be transformed into a compressed stream signal (step 207). When the above-described steps are completed, the compressed stream signal is multiplexed and transmitted to the outside (step 209).

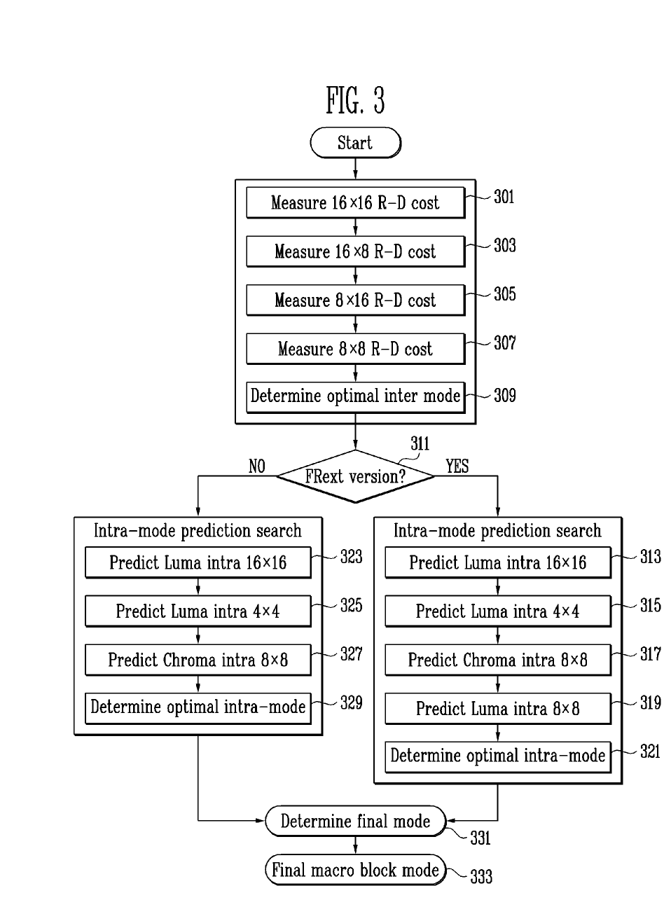

FIG. 3 is a diagram schematically showing the sequence for motion prediction according to the related art, which is compared with the present invention.

In screen compression using the H.264 scheme, a screen is divided into a plurality of macro blocks (MB) so as to perform an inter-mode prediction and an intra-mode prediction. Therefore, a Rate-Distortion (R-D) cost of the inter mode is first measured to determine an optimal inter mode. In response to the determined inter mode, the intra-mode prediction is performed.

Referring to FIG. 3, an R-D cost is measured for a 16×16 macro block (step 301), an R-D cost is measured for a 16×8 macro block (step 303), an R-D cost is measured for an 8×16 macro block (step 305), and an R-D cost is measured for an 8×8 macro block (step 307).

The reason why the R-D cost for each macro block is measured is because a 16×16 skip mode, a 16×16 mode, an 8×16 mode, a 16×8 mode, and an 8×8 mode are present in each variable block formed in the inter mode. In particular, as for 8×8 mode sub modes, an 8×8 mode, an 8×4 mode, a 4×8 mode, and a 4×4 mode are subsidiarily present.

In this way, all the R-D costs of the respective variable blocks which can be implemented in the inter mode are measured. Then, the R-D costs of the respective blocks are compared to determine an optimal inter mode having the minimum value (step 309).

Next, it is checked whether the prediction scheme is the Fidelity Range Extensions (FRExt) version or not (step 311). When the prediction scheme is the FRExt version, 16×16 Luminance (luma) prediction search in the intra-mode prediction is performed (step 313), 4×4 luma prediction search is performed (step 315), 8×8 Chrominance (Chroma) prediction search is performed (step 317), and 8×8 luma prediction search is performed (step 319). Then, the respective prediction search values are compared to determine an optimal intra-mode (step 321).

Otherwise, when the prediction scheme is not the FRExt version, 16×16 luma prediction search in the intra-mode prediction is performed (step 323), 4×4 luma prediction search is performed (step 325), and 8×8 chroma prediction search is performed (step 327). Then, the prediction search values are compared to determine an optimal intra-mode (step 329).

Next, a final mode is determined using the optimal intra and inter modes (step 331). The final mode becomes a final mode of the macro block in which the compression is performed (step 333).

In this type of scheme, however, a large amount of calculation is needed for the search of the inter mode. Further, since the search of the intra-mode needs to be performed thoroughly, an amount of calculation increases. Therefore, there are many difficulties in performing video compression in real time.

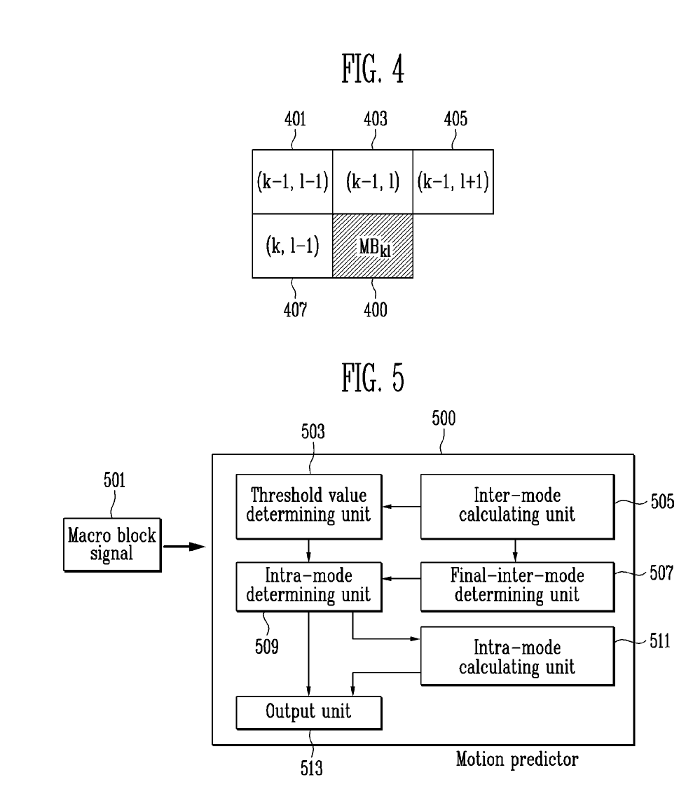

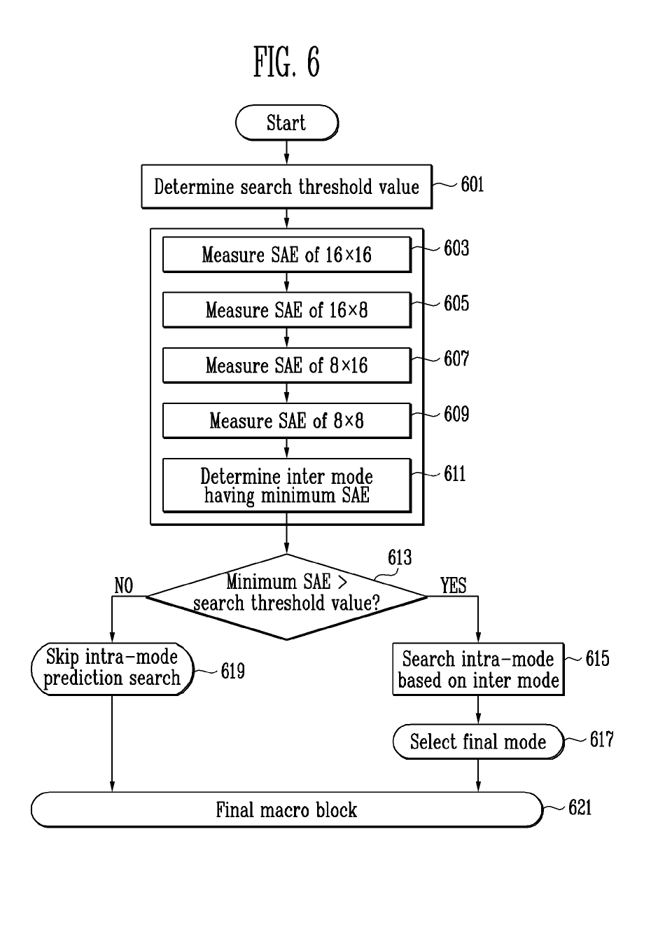

FIG. 4 is a diagram for explaining a macro block which is applied in the H.264 scheme.

Referring to FIG. 4, the position of each macro block in the entire screen frame is described. When it is assumed that MBkl represents the coordinates of a macro block 400 which is currently processed, the macro blocks in the frame are sequentially processed in a direction from the left upper portion to the right lower portion. Therefore, when the macro block 400 at MBkl is processed, four neighboring macro blocks may occur in the upper side and the left side thereof. That is, a left block 407 at (k, l−1) occurs in the left side, and a right upper block 405 at (k-1, l+1), an upper block 403 at (k-1, l), and a left upper block 401 at (k-1, l−1) occur in the upper side. When the macro block 400 is processed in this method, a screen can be compressed by comparing the value of the macro block 400 with the pre-processed values of the neighboring macro blocks.

FIG. 5 is a schematic view of the motion predictor for screen motion prediction according to an exemplary embodiment of the present invention.

Referring to FIG. 5, the motion predictor 500 according to the present invention includes a threshold value determining unit 503, an inter-mode calculating unit 505, a final-inter-mode determining unit 507, an intra-mode determining unit 509, an intra-mode calculating unit 511, and an output unit 513.

The threshold value determining unit 503 serves to determine a threshold value of an input macro block signal 501 using pre-calculated R-D costs of neighboring macro blocks.

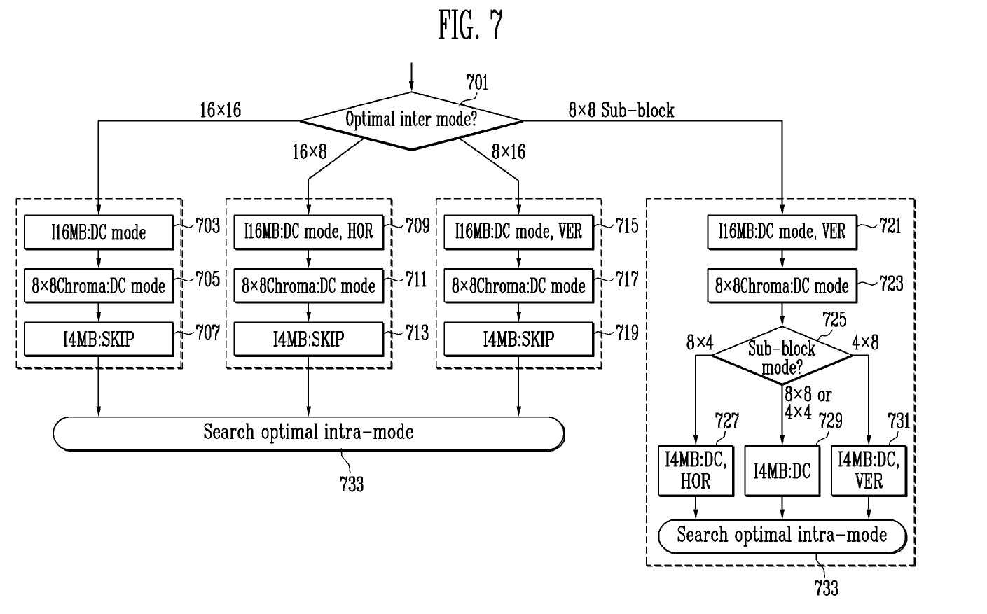

The determining of the threshold value will be described in more detail with reference to FIG. 6.

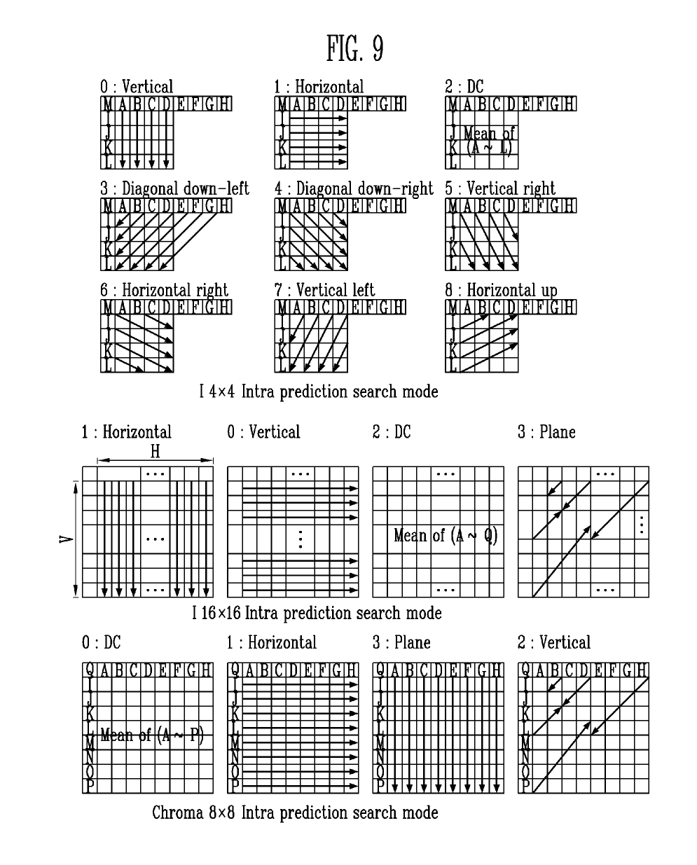

The inter-mode calculating unit 505 serves to calculate the inter mode of the input macro block signal 501. Further, the inter-mode calculating unit 505 calculates the sum of absolute error (SAE) in each inter mode which will be described in FIG. 8. The calculating of the inter mode will be described in more detail with reference to FIG. 6.

The final-inter-mode determining unit 507 serves to determine an inter mode having the minimum SAE by using the SAE of each inter mode calculated by the inter-mode calculating unit 505.

The intra-mode determining unit 509 serves to determine whether or not to calculate an intra-mode by comparing the threshold value determined by the threshold value determining unit 503 having the SAE of the optimal inter mode determined by the inter-mode determining unit 507.

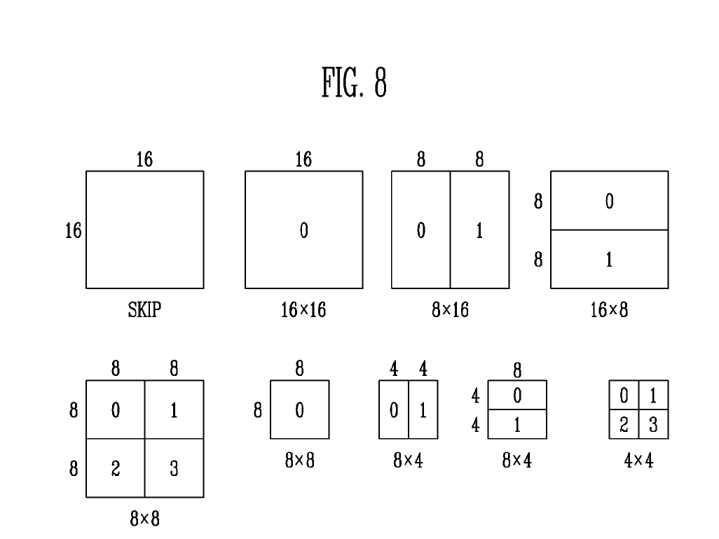

The intra-mode calculating unit 511 serves to calculate an intra-mode when it is determined that the intra-mode determining unit 509 will calculate an intra-mode. The calculating of the intra-mode by the intra-mode calculating unit 511 will be described in more detail with reference to FIG. 7.

The output unit 513 serves to transmit a signal, which is compressed by performing the intra-mode and inter-mode prediction search on the input macro block signal through the above-described method, to the outside.

FIG. 6 is a diagram schematically showing the sequence for screen motion prediction according to an exemplary embodiment of the present invention.

Referring to FIG. 6, a search threshold value is first determined (step 601). The search threshold value is an important factor for determining whether or not to perform the intra-mode prediction search in the subsequent step.

The search threshold value can be obtained by Expression 1.

Tkl=min RD Costij {RD cost(m, n)|(m, n) ε Neighbors} [Expression 1]

Here, Tkl represents a search threshold value, and RD cost represents a Rate-Distortion cost.

Further, (m, n) means an index value with respect to a neighboring block, and kl indicates a macro block which is desired to be currently processed.

The respective index values (m, n) and the position of the macro block kl on the frame are described in FIG. 4. Since the macro blocks are constructed on the screen as described in FIG. 4, a search threshold value is determined using neighboring blocks. Then, the SAE of the current macro block according to the inter-mode variable blocks is calculated.

First, the SAE of a 16×16 macro block is measured (step 603), the SAE of a 16×8 macro block is measured (step 605), the SAE of an 8×16 macro block is measured (step 607), and the SAE of an 8×16 macro block is measured (step 609).

After the SAE for each variable block is measured, an inter mode having the minimum SAE is determined (step 611).

Next, it is judged whether the minimum SAE is larger than the search threshold value or not (step 613). When the minimum SAE is not larger than the search threshold value, the intra-mode prediction search is omitted (step 619). Otherwise, an intra-mode is searched on the basis of the inter mode having the minimum SAE, which has been determined in step 611 (step 615).

Then, a final mode is selected (step 617) and is determined as a mode of the final macro block (step 621).

FIG. 7 is a diagram showing an intra-mode search method based on an inter mode according to an exemplary embodiment of the present invention.

FIG. 7 describes step 615 of FIG. 6 in detail. Referring to FIG. 7, the optimal inter mode is checked (step 701). The optimal inter mode is determined in step 611 of FIG. 5.

Then, when the optimal inter mode is a 16×16 mode, Intra 16×16 Macro Block Luminance (I16MB):directionless (DC) mode is first performed (step 703). Further, an 8×8 chroma:DC mode is performed (step 705), and I4 MB is skipped (step 707) so as to search an optimal intra-mode (step 733).

When the optimal inter mode is a 16×8 mode, an I16 MB:DC mode and horizontal (HOR) mode is performed first (step 709). Further, an 8×8 chroma:DC mode is performed (step 711), and I4 MB is skipped (step 713) so as to search an optimal intra-mode (step 733).

When the optimal inter mode is an 8×16 mode, an I16 MB:DC mode and vertical (VER) mode is performed first (step 715). Further, the 8×8 chroma:DC mode is performed (step 727), and the I4 MB is skipped (step 719) so as to search an optimal intra-mode (step 733).

Finally, when the optimal inter mode has an 8×8 sub mode, the I16 MB:DC mode and VER mode is performed (step 721), and the 8×8 chroma:DC mode is performed (step 723). The sub-block of the 8×8 mode is judged (step 725). When the sub-block is an 8×4 mode, the I4 MB:DC mode and HOR mode is performed (step 727). When the sub-block is an 8×8 mode or 4×4 mode, the I4 MB:DC mode is performed (step 729). When the sub-block is a 4×8 mode, the I4 MB:DC mode and HOR mode is performed (step 731).

After the respective modes are performed, an optimal intra-mode is searched (step 733).

When such an intra-mode prediction search is compared with the conventional intra-mode prediction search, it can be found that the number of prediction modes for the intra-mode is reduced in response to the respective inter modes. Therefore, an amount of calculation is reduced in comparison with the conventional intra-mode prediction search, which makes it possible to effectively compress a real-time video signal.

FIG. 10 is a diagram for explaining an actual exemplary embodiment when the present invention is applied.

Referring to FIG. 10, when a frame 1000 of a video signal which is to be compressed is input, it is divided into a plurality of macro blocks composing a divided frame 1010.

In the H.264 scheme, the respective macro blocks are not divided into identical macro blocks, but are predicted and searched as variable blocks with sizes described in FIG. 8 by the inter-mode prediction scheme, depending on the luminance or chrominance of an image existing in the video signal.

As indicated by reference numerals 1011 and 1013, the variable blocks searched by the inter-mode prediction scheme can be separated into the variable blocks described in FIG. 8. Depending on the respective blocks, the intra-mode prediction search method differs.

In the conventional scheme, all the intra-mode search methods are performed regardless of the types of the blocks, as shown in FIG. 3. In the present invention, however, intra-modes are determined by different methods, depending on the search threshold value obtained by referring to the neighboring macro blocks and the SAE according to the respective variable blocks, as shown in FIG. 7. That is, the intra-mode predication search is performed differently on the blocks 1011 and 1013, respectively.

For example, when the block 1011 has an 8×8 sub-block 1021, the intra-mode prediction search is performed only for the I16 MB:DC mode, the 8×8 Chroma:DC mode, and the I4 MB:DC mode along the procedure of the 8×8 sub-block of FIG. 7.

Further, when the block 1013 has an 8×16 block 1023, the intra-mode prediction search is performed only for the I16 MB:DC mode and HOR mode and the 8×8 Chroma:DC mode along the procedure of the 8×16 block of FIG. 7.

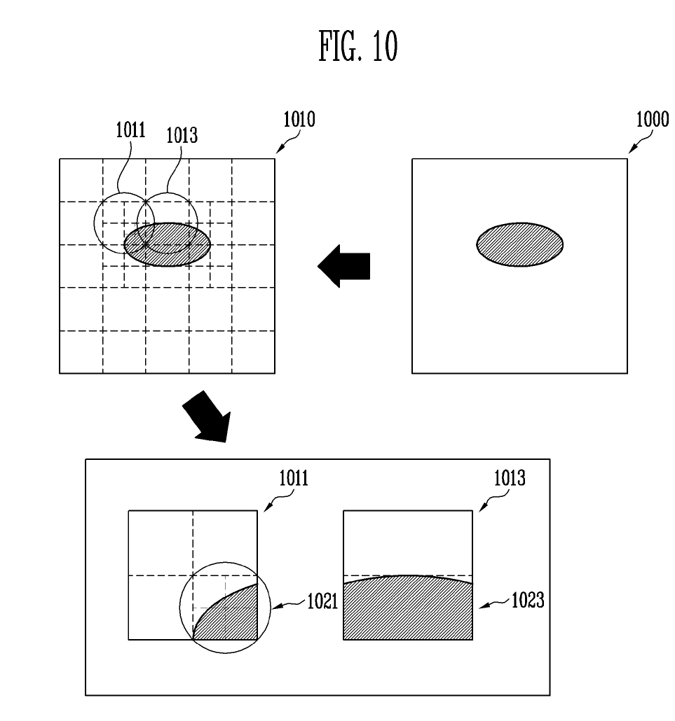

In this case, only three kinds of intra-mode prediction searches are performed for the blocks 1011 and 1013. In the conventional scheme, however, all kinds of intra-mode prediction searches of the respective modes described in FIG. 9 have to be performed, which means that at least 17 kinds of intra-mode prediction searches should be performed. Therefore, an amount of calculation is reduced in comparison with the conventional scheme, which makes it possible to effectively compress a real-time video signal.

According to the present invention, it is possible to provide a method and apparatus for intra-mode prediction search for real-time compression of a video signal.

Further, the intra-mode prediction search of the inter-mode prediction search and the intra-mode prediction search is accelerated, which makes it possible to improve the performance of the H.264 video compression system in terms of bit rate and compression speed.

While the present invention has been shown and described with reference to certain exemplary embodiments thereof, it will be understood by those skilled in the art that various changes in form and details may be made therein without departing from the spirit and scope of the present invention as defined by the appended claims.

What is claimed is:

1. An intra-mode prediction search method for compression of a real-time video signal, the method comprising the steps of:
measuring a Rate-Distortion (R-D) cost of a video-signal macro block received from outside;
determining a search threshold value by comparing the R-D cost of the received macro block with R-D costs of neighboring macro blocks;
determining an inter mode having the minimum sum of absolute error (SAE) by measuring the SAE of the received macro block for each inter mode; and
determining an intra-mode prediction search in response to the minimum SAE of the determined inter mode and the search threshold value.

2. The method according to claim 1, wherein in the step of determining the intra-mode prediction search, when the minimum SAE of the determined inter mode exceeds the search threshold value, the intra-mode prediction search is skipped.

3. The method according to claim 1, wherein in the step of determining the intra-mode prediction search, when the minimum SAE of the determined inter mode is smaller than or equal to the search threshold value, the intra-mode prediction search is performed in response to the inter mode having the minimum SAE.

4. The method according to claim 3, further comprising the step of:
when the inter mode having the minimum SAE is a 16×16 mode, predicting and searching an optimal intra-mode by performing the intra-mode prediction search in an Intra 16×16 Macro Block Luminance (I16 MB):DC mode and an Intra 8×8 Chrominance (Chroma):DC mode and skipping the intra-mode prediction search in an I4 MB:DC mode.

5. The method according to claim 3, further comprising the step of:
when the inter mode having the minimum SAE is a 16×8 mode, predicting and searching an optimal intra-mode by performing the intra-mode prediction search in an I16 MB:DC and HOR mode and an Intra 8×8 Chroma:DC mode and skipping the intra-mode prediction search in an I4 MB:DC mode.

6. The method according to claim 3, further comprising the step of:
when the inter mode having the minimum SAE is an 8×16 mode, predicting and searching an optimal intra-mode by performing the intra-mode prediction search in an I16 MB:DC and VER mode and an Intra 8×8 Chroma:DC mode and skipping the intra-mode prediction search in an I4 MB:DC mode.

7. The method according to claim 3 further comprising the steps of:
when the inter mode having the minimum SAE has an 8×8 sub-block, performing the intra-mode prediction search in an I16 MB:DC mode and an Intra 8×8 Chroma:DC mode;
when the sub-block mode is an 8×4 mode, performing the intra-mode prediction search in an I4 MB:DC and HOR mode;
when the sub-block mode is any one of an 8×8 mode and a 4×4 mode, performing the intra-mode prediction search in an I4 MB:DC mode; and
when the sub-block mode is a 4×8 mode, performing the intra-mode prediction search in an I4 MB:DC and VER mode.

8. An intra-mode prediction search apparatus for compression of a real-time video signal, the apparatus comprising:
a threshold value determining unit for measuring an R-D cost of a video-signal macro block received from outside and determining a search threshold value by comparing the R-D cost of the received macro block with R-D costs of neighboring macro blocks;
an inter-mode calculating unit for measuring the sum of absolute error (SAE) of the received macro block for each inter mode;
a final-inter-mode determining unit for determining a final inter mode having the minimum SAE for the respective inter modes by comparing the measured SAEs; and
an intra-mode determining unit for determining an intra-mode prediction search in response to the minimum SAE of the determined final inter mode and the search threshold value.

9. The apparatus according to claim 8, wherein the intra-mode determining unit skips the intra-mode prediction search, when the minimum SAE of the determined final inter mode exceeds the search threshold value.

10. The apparatus according to claim 8, wherein the intra-mode determining unit comprises an intra-mode calculating unit for predicting and searching an intra-mode in response to the final inter mode having the minimum SAE.

11. The apparatus according to claim 10, wherein the intra-mode calculating unit comprises a 16×16 intra-mode predicting and searching section for predicting and searching an optimal intra-mode by performing the intra-mode prediction search in an I16 MB:DC mode and an Intra 8×8 Chroma:DC mode and skipping the intra-mode prediction search in an I4 MB:DC mode.

12. The apparatus according to claim 10, wherein the intra-mode calculating unit comprises a 16×8 intra-mode predicting and searching section for predicting and searching an optimal intra-mode by performing the intra-mode prediction search in an I16 MB:DC and HOR mode and the Intra 8×8 Chroma:DC mode and skipping the intra-mode prediction search in the I4 MB:DC mode.

13. The apparatus according to claim 10, wherein the intra-mode calculating unit comprises an 8×16 intra-mode predicting and searching section for predicting and searching an optimal intra-mode by performing the intra-mode prediction search in an I16 MB:DC and VER mode and the Intra 8×8 Chroma:DC mode and skipping the intra-mode prediction search in the I4 MB:DC mode.

14. The apparatus according to claim 10, wherein the intra-mode calculating unit comprises an 8×8 sub-block intra-mode predicting and searching section for performing the intra-mode prediction search in at least one of the I16 MB:DC mode, the Intra 8×8 Chroma:DC mode, the I4 MB:DC and HOR mode, the I4 MB:DC mode, and the I4 MB:DC and VER mode.
